(19) United States
(12) Patent Application Publication
(10) Pub. No.: US 2026/0094913 A1
(43) Pub. Date: Apr. 2, 2026

(54) PULL TAB TAPE AND METHOD OF MANUFACTURING PULL TAB TAPE

(71) Applicant: SAMSUNG SDI CO., LTD., Yongin-si, Gyeonggi-do (KR)

(72) Inventors: JaeHyuk Choi, Yongin-si (KR); MOORYONG BAEK, Yongin-si (KR); Kangsik An, Yongin-si (KR)

(21) Appl. No.: 19/347,066

(22) Filed: Oct. 1, 2025

(30) Foreign Application Priority Data
Oct. 2, 2024 (KR) 10-2024-0134372

(51) Int. Cl. H01M 50/244; H01M 50/247; H01M 50/264; H01M 50/30

(52) U.S. Cl. CPC H01M 50/244; H01M 50/247; H01M 50/264; H01M 50/394

(57) ABSTRACT

A pull tab tape to be provided in a battery mounting part of a terminal device powered by a battery is provided. The pull tab tape includes: a seated part on which the battery is seated, the seated part having an adhesive surface facing the battery and having an area smaller than an area of the battery on the seated part; and a tab part exposed to an outside on a surface that faces the surface of the seated part on which the battery is seated when the battery is seated in the terminal device.

### CROSS-REFERENCE TO RELATED APPLICATION

The present application claims priority to and the benefit of Korean Patent Application No. 10-2024-0134372, filed on October 2, 2024, in the Korean Intellectual Property Office, the entire disclosure of which is incorporated herein by reference.

### BACKGROUND

### 1. Field

Aspects of embodiments of the present disclosure relate to a pull tab tape and a method of manufacturing a pull tab tape.

### 2. Description of the Related Art

Different from primary batteries, which are not designed to be charged, secondary batteries are designed to be discharged and recharged. Low-capacity secondary batteries are used in small, portable electronic devices, such as smart phones, feature phones, notebook computers, digital cameras, and camcorders, while large-capacity secondary batteries are widely used as power sources for driving motors, such as of hybrid vehicles or electric vehicles, and for power storage. A secondary battery generally includes an electrode assembly including (or consisting of) a positive electrode and a negative electrode, a case that accommodates the electrode assembly, a terminal part connected to the electrode assembly, etc.

In a terminal device, such as a smartphone or a tablet, that is powered by a battery, a pull tab tape may be provided between a battery mounting part on which the battery is mounted and the battery. The pull tab tape may have a tab that is exposed to the outside when the battery is mounted in the terminal device. Accordingly, a user can easily remove the battery from the terminal device by pulling the tab that is exposed to the outside. Such a pull tab tape generally has an adhesive surface on which the battery is seated to be attached to the battery. An opposite surface as the adhesive surface on which the battery is seated is attached to a tape mounting part by a double-sided adhesive tape. However, if the terminal device is twisted during use, the adhesive surface of the pull tab tape on which the battery is seated may be detached and re-attached. Furthermore, the adhesive surface of the pull tab tape is easily detached when a terminal device is dropped.

The above information disclosed in this Background section is for enhancement of understanding of the background of the present disclosure, and therefore, it may contain information that does not constitute related (or prior) art.

### SUMMARY

Embodiments of the present disclosure provide a pull tab tape having an adhesive surface having an area smaller than an area of a battery on the pull tab tape.

However, aspects and features of the present disclosure are not limited those described above, and other aspects and features not expressly mentioned herein will be clearly understood by those skilled in the art from the description of the present disclosure below.

A pull tab tape, according to embodiments of the present disclosure, is to be provided in a battery mounting part of a terminal device that is powered by a battery. The pull tab tape includes: a seated part on which the battery is seated, the seated part having an adhesive surface facing the battery and having an area smaller than an area of the battery on the seated part; and a tab part exposed to an outside on a surface that faces the surface of the seated part on which the battery is seated when the battery is seated in the terminal device.

The adhesive surface of the seated part may be at a central region thereof and may not be at a plurality of corner parts of the seated part on which the battery is seated.

The adhesive surface may be formed by a plurality of adhesive dots on the seated part, and the plurality of adhesive dots may be on the central region of the seated part on which the battery is seated and may not be at the plurality of corner parts of the seated part on which the battery is seated.

The plurality of corner parts of the seated part may be removed from the seated part.

The seated part may have a strong adhesive line having an adhesive stronger than another part of the adhesive surface.

The strong adhesive line of the seated part may be at an edge of the adhesive surface.

The strong adhesive line of the seated part may extend across the adhesive surface in an X shape.

The strong adhesive line of the seated part may be within the seated part at a distance from an edge of the adhesive surface.

The pull tab tape may further include a side cover part extending around a side of the battery.

The side cover part may have air vents through which air displaced when the battery is seated on the seated part passes.

According to another embodiment of the present disclosure, a method of manufacturing a pull tab tape to be provided in a battery mounting part of a terminal device that is powered by a battery includes: manufacturing a tape including a seated part on which the battery is seated and a tab part exposed to an outside on a surface that faces a surface on which the battery is seated when the battery is seated; and forming an adhesive surface on the seated part, the adhesive surface having an area smaller than an area of the battery on the surface of the seated part.

The forming of the adhesive surface may include forming the adhesive surface of the seated part on a central region of the surface on which the battery is seated and not at a plurality of corner parts of the surface on which the battery is seated.

The forming of the adhesive surface may include forming a plurality of adhesive dots to form the adhesive surface on an inside of the surface on which the battery is seated and not at a plurality of corner parts of the surface on which the battery is seated.

The method may further include removing the plurality of corner parts from the seated part.

The method may further include forming a strong adhesive line having an adhesive surface that is stronger than another part of the adhesive surface on a part of the adhesive surface of the seated part.

The forming of the strong adhesive line may include forming the strong adhesive line on the seated part at an edge of the adhesive surface.

The forming of the strong adhesive line may include forming the strong adhesive line on the seated part to extend across the adhesive surface in an X shape.

The forming of the strong adhesive line may include forming the strong adhesive line of the seated part at a distance from an edge of the adhesive surface.

The manufacturing of the tape may include forming a side cover part that extends around a side of the battery.

The manufacturing of the tape may include the side cover part comprises forming air vents through which air that is displaced when the battery is seated on the seated part passes through in the side cover part.

According to embodiments of the present disclosure, the adhesive surface having an area smaller than the area of a battery is formed on the surface on which the battery is seated. Accordingly, when a terminal device to which the battery is mounted is twisted, a joint that occurs when the adhesive surface of the surface of the pull tab tape on which the battery is seated is detached and reattached can be prevented.

According to embodiments of the present disclosure, the adhesive surface of the pull tab tape is rarely detached when a terminal device is dropped because the strong adhesive line having the adhesive surface stronger than another part of the adhesive surface is formed in a part of the adhesive surface.

According to embodiments of the present disclosure, dimensional defects or a poor appearance may be avoided by preventing the formation of bubbles by including air vents through which air that is displaced when the battery is seated on the seated part can escape is formed in the side cover part that extends around the side of the battery.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure and further describe the technical spirit of the present disclosure along with the detailed disclosure. Accordingly, the present disclosure should not be construed as being limited to the contents described in such drawings, in which:

FIGS. 1A and 1B are schematic diagrams of a pouch type lithium secondary battery.

FIG. 2 is a diagram illustrating a battery being removed from a terminal device through a pull tab tape.

FIG. 3 is a diagram of a conventional pull tab tape.

FIG. 4 is a side cross-sectional view of the conventional pull tab tape applied to the terminal device.

FIG. 5 is a side cross-sectional view illustrating a case in which the terminal device is twisted while the conventional pull tab tape is applied to the terminal device.

FIG. 6 is a side cross-sectional view illustrating a case in which a terminal device is twisted while a pull tab tape according to embodiments of the present disclosure is applied to the terminal device.

FIG. 7 is a diagram of an adhesive surface of a seated part of the conventional pull tab tape.

FIG. 8 is a diagram illustrating a pull tab tape according to an embodiment of the present disclosure.

FIG. 9 is a diagram illustrating a pull tab tape according to another embodiment of the present disclosure.

FIG. 10 is a side cross-sectional view of a case in which a terminal device is twisted while the pull tab tape according to an embodiment of the present disclosure is applied to the terminal device.

FIG. 11 is a diagram illustrating a pull tab tape according to another embodiment of the present disclosure.

FIG. 12 is a diagram illustrating a pull tab tape according to another embodiment of the present disclosure.

FIG. 13 is a diagram illustrating a pull tab tape according to another embodiment of the present disclosure.

FIG. 14 is a flowchart describing a method of manufacturing a pull tab tape according to an embodiment of the present disclosure.

### DETAILED DESCRIPTION

Embodiments of the present disclosure will be described below, in detail, with reference to the accompanying drawings. Prior to the description, it is noted that the terms or words used in this specification and claims should not be construed as being limited to common or dictionary meanings but instead should be understood to have meanings and concepts consistent with the spirit of the present disclosure based on the principle that an inventor can define the concept of each term suitably in order to describe his/her own invention in the best way possible. Accordingly, because the embodiments described in this specification and the configurations illustrated in the drawings are only examples of the present disclosure and do not cover all the technical ideas of the present disclosure, it should be understood that various changes and modifications may be made at the time of filing this application.

It will be further understood that the terms "comprises/includes" and/or "comprising/including" when used herein, specify the presence of stated features, integers, steps, operations, elements, components, and/or groups thereof, but do not preclude the presence or addition of one or more other features, integers, steps, operations, elements, components, and/or groups thereof.

To facilitate understanding of the present disclosure, the accompanying drawings are not drawn to scale and the dimensions of some components may be exaggerated. It should be noted that the same reference numerals are designated to the same components in different embodiments.

Reference to two compared elements, features, etc. as being "the same" means that they are "substantially the same". Therefore, the phrase "substantially the same" may include a deviation that is considered low in the art, for example, a deviation of about 5% or less. The uniformity of any parameter in a given region may mean that it is uniform from an average perspective.

Although the terms such as "first" and/or "second" are used to describe various components, these components are not limited by these terms, of course. These terms are only used to distinguish one component from another component. Thus, unless specifically stated to the contrary, a first component may be termed a second component without departing from the teachings of exemplary embodiments.

Throughout the specification, unless otherwise stated, each element may be singular or plural.

Arrangement of any component "above (or below)" or "on (or under)" a component may mean that any component is disposed in contact with the upper (or lower) surface of the component, as well as that other components may be interposed between the element and any element disposed on (or under) the element.

It will be understood that, when a component is referred to as being "connected", "coupled", or "joined" to another component, not only can it be directly "connected", "coupled", or "joined" to the other element, but also can it be indirectly "connected", "coupled", or "joined" to the other element with other elements interposed therebetween.

As used herein, the term "and/or" includes any and all combinations of one or more of the associate listed items. The use of "may" when describing embodiments of the present disclosure relates to "one or more embodiments of the present disclosure". Expressions such as "at least one" and "one or more" preceding a list of elements modify the entire list of elements and do not modify the individual elements in the list.

Throughout the specification, when "A and/or B" is stated, it means A, B, or A and B, unless otherwise stated. In addition, when "C to D" is stated, it means C or more and D or less, unless specifically stated to the contrary.

When the phrase such as "at least one of A, B, and C", "at least one of A, B, or C", "at least one selected from the group of A, B, and C", or "at least one selected from among A, B, and C" is used to designate a list of elements A, B, and C, the phrase may refer to any and all suitable combinations.

The term "use" may be considered synonymous with the term "utilize". As used herein, the terms "substantially," "about," and similar terms are used as terms of approximation rather than as terms of degree, and are intended to account for inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Accordingly, a first element, component, region, layer, or section discussed below may be termed a second element, component, region, layer, or section without departing from the teachings of exemplary embodiments.

For ease of explanation in describing the relationship of one element or feature to another element(s) or feature(s) as illustrated in the drawings, spatially relative terms such as "beneath", "below", "lower", "above", and "upper" may be used herein. It will be understood that spatially relative positions are intended to encompass different directions of the device in use or operation in addition to the direction depicted in the drawings. For example, if the device in the drawings is turned over, any element described as being "below" or "beneath" another element would then be oriented "above" or "over" another element. Therefore, the term "below" may encompass both upward and downward directions.

The terminology used herein is for the purpose of describing embodiments of the present disclosure and is not intended to limit the present disclosure.

The type of secondary battery referenced herein includes a coin type, a cylindrical type, a prismatic type, and a pouch type. Prior to a description of embodiments of the present disclosure, a pouch type secondary battery is generally described because embodiments of the present disclosure may be readily applied to the pouch type secondary battery. However, the present disclosure is not limited thereto, and embodiments of the present disclosure may be applied to other types of batteries

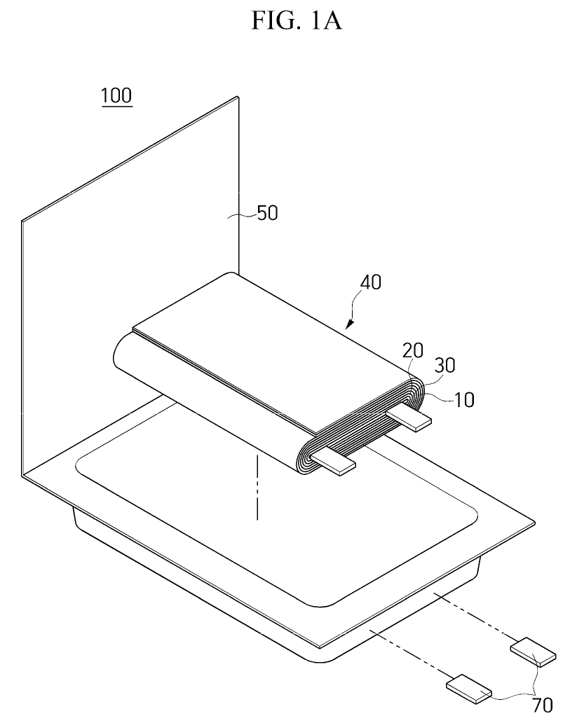

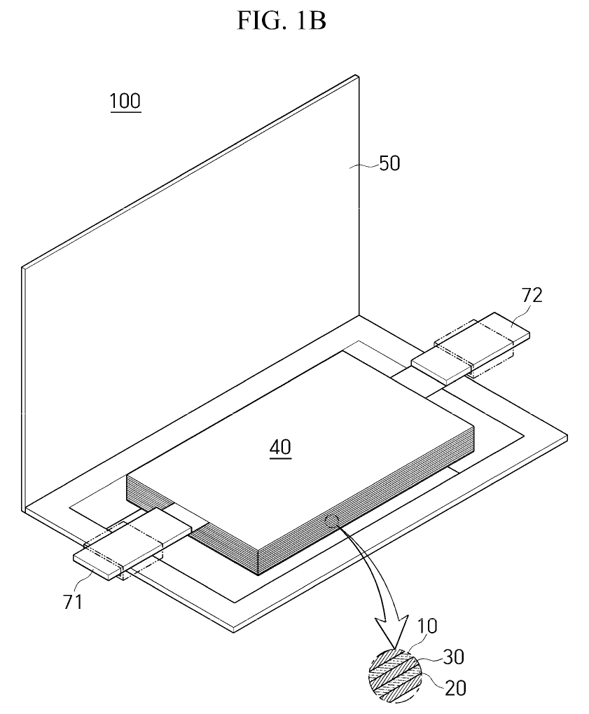

Referring to FIG. 1A and 1B, a pouch type secondary battery may include an electrode assembly 40, in which a separator 30 is interposed between a first electrode plate 10 and a second electrode plate 20, and a case 50 in which the electrode assembly 40 is accommodated (or has been embedded). The first electrode plate 10, the second electrode plate 20, and the separator 30 may be impregnated in an electrolyte. The pouch type secondary battery may also include an electrode tab 70 that acts as an electrical passage for moving a current formed in (or stored in) the electrode assembly 40 toward the outside. The electrode tab 70 may include a first electrode tab 71 and a second electrode tab 72.

The electrode assembly 40 may be formed by winding or stacking a stacked body including the first electrode plate 10, the second electrode plate 20, and the separator 30, each of which is formed in a plate or film shape. In the winding type electrode assembly, the winding axis of the electrode assembly 40 may be parallel to a length direction of the case. Furthermore, the electrode assembly 40 may be the stack type, rather than the winding type, but a shape of the electrode assembly 40 is not limited in embodiments of the present disclosure. The first electrode plate 10 of the electrode assembly 40 may act as a positive electrode, and the second electrode plate 20 thereof may act as a negative electrode, and vice versa.

The first electrode plate 10 may be formed by applying a first electrode active material, such as graphite or carbon, to a first electrode collector plate formed of a metal foil, such as copper, a copper alloy, nickel, or a nickel alloy, and may include a first electrode tab (e.g., a first uncoated part), that is, an area at where the first electrode active material is not been applied.

The second electrode plate 20 may be formed by applying a second electrode active material, such as a transition metal oxide, to a second electrode collector plate formed of a metal foil, such as aluminum or an aluminum alloy, and may include a second electrode tab (e.g., a second uncoated part), that is, an area at where the second electrode active material is not been applied.

The separator 30 may prevent a short-circuit between the first electrode plate 10 and the second electrode plate 20 while permitting movement of lithium ions therebetween. The separator 30 may include (or may be composed of) a polyethylene film, a polypropylene film, or a polyethylene-polypropylene film, for example.

The case 50 may be a laminate film or may be a plastic material in a pouch form or type. The case 50 is sealed at the sealing portions along the edges thereof contacting each other while accommodating the electrode assembly 40 therebetween. The case 50 is sealed while the electrode tab 70, or the positive electrode tab 71 and the negative electrode tab 72, is between the sealing portions. The sealing portion of the case 50 is made of a heat-melting material and has a structure in which sealing is achieved by bonding heat-melting layers to each other.

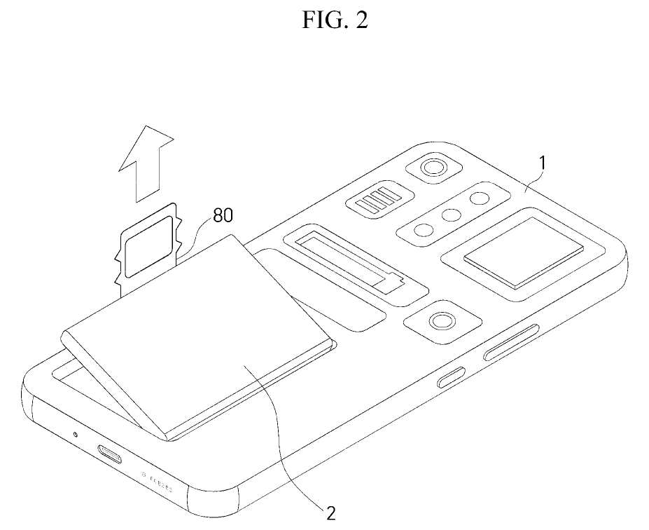

FIG. 2 is a diagram illustrating a battery being removed from a terminal device by using a pull tab tape.

Referring to FIG. 2, in a terminal device 1, such as a smartphone or a tablet that is powered by a battery 2, a pull tab tape 80 may be provided between a battery mounting part on which the battery 2 is mounted and the battery 2. A tab that is exposed to the outside when the battery 2 is mounted in the terminal device 1 may be formed in the pull tab tape 80. Accordingly, a user can easily dismantle (e.g., remove) the battery 2 because the tab is accompanied by the battery 2 when pulling the tab exposed to the outside to dismantle the battery 2.

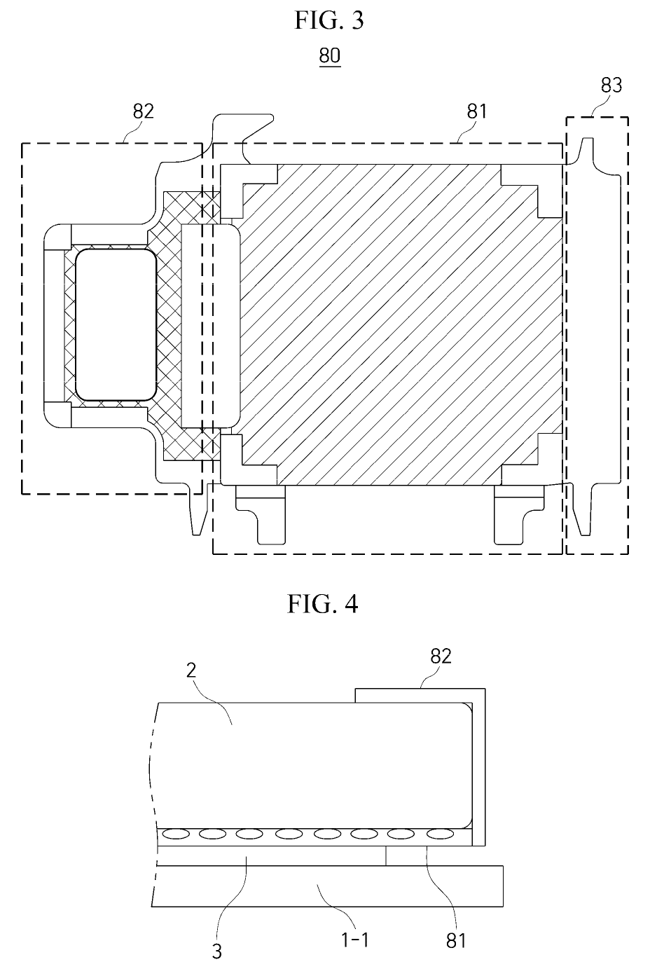

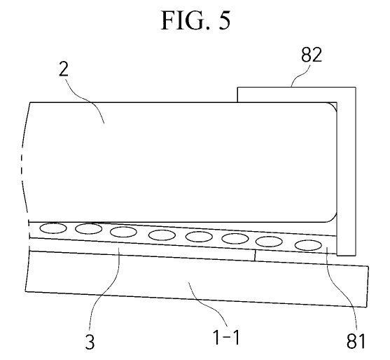

FIG. 3 is a diagram illustrating a conventional pull tab tape. FIG. 4 is a side cross-sectional view illustrating the conventional pull tab tape applied to the terminal device. FIG. 5 is a side cross-sectional view illustrating a case in which the terminal device is twisted while the conventional pull tab tape is applied to the terminal device.

Referring to FIGS. 3 to 5, the pull tab tape 80 may have a seated part 81 on which the battery 2 is seated, a tab part 82 exposed to the outside when the battery 2 is seated (e.g., exposed or extending beyond the battery 2), and a side cover part 83 that extends around (or covers) a side of the battery 2.

As illustrated in FIG. 4, the pull tab tape 80 may be attached to the battery 2 by having an adhesive surface corresponding to the area of the pull tab tape 80 at where the battery 2 is seated. A rear surface opposite to the surface on which the battery 2 is seated may be attached to a tape mounting part 1-1 through a double-sided adhesive tape 3.

As illustrated in FIG. 5, when the terminal device 1 is twisted during use, a joint may occur when the adhesive surface of the pull tab tape 80 on which the battery 2 is seated is detached and re-attached. Furthermore, the adhesive surface of the pull tab tape 80 is easily detached when the terminal device 1 is dropped. For example, as illustrated in FIG. 5, a joint phenomenon or a phenomenon in which the adhesive surface is detached at a corner part of the surface on which the battery 2 is seated frequently occurs.

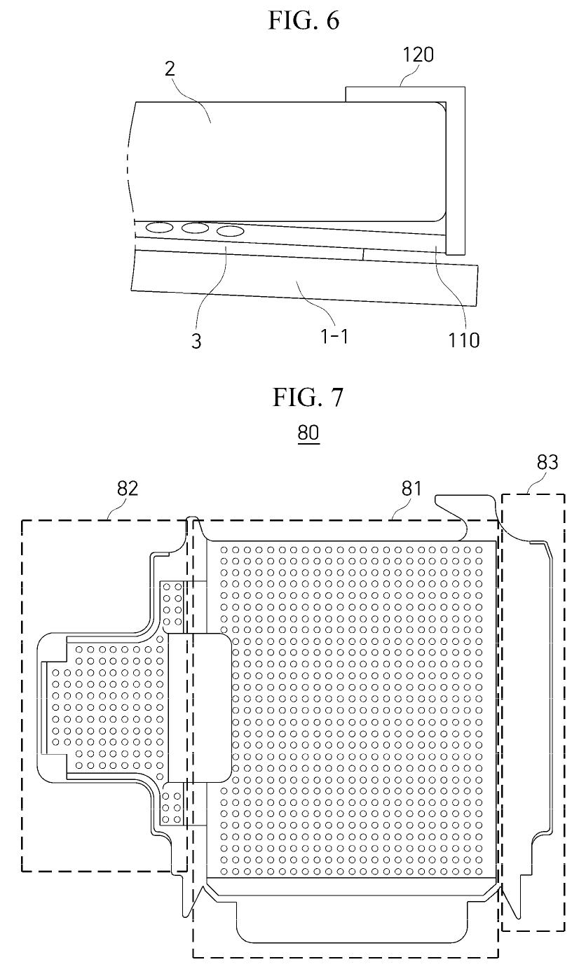

FIG. 6 is a side cross-sectional view illustrating a case in which a terminal device is twisted while a pull tab tape according to an embodiment of the present disclosure is applied to the terminal device.

Referring to FIG. 6, an adhesive surface of a pull tab tape, according to an embodiment of the present disclosure, may be formed on the surface (e.g., the inner surface) of the pull tab tape on which the battery 2 is seated other than at a plurality of corner parts of the surface of the pull tab tape 100 on which the battery 2 is seated so that the joint phenomenon or the phenomenon in which the adhesive surface is detached at the corner part of the surface on which the battery 2 is seated is avoided. Embodiments of the pull tab tape according to embodiments of the present disclosure are described below with reference to the drawings based on such a concept.

FIG. 7 is a diagram of a seated part of the conventional pull tab tape.

Referring to FIG. 7, the adhesive surface may be formed in the conventional pull tab tape 80 with respect to (or corresponding to) the entire surface on which the battery 2 is seated, that is, the area of the battery 2. Accordingly, a joint phenomenon or a phenomenon in which an adhesive surface is detached at a corner part of a surface on which the battery 2 is seated, such as that described above with reference to FIG. 5, may occur.

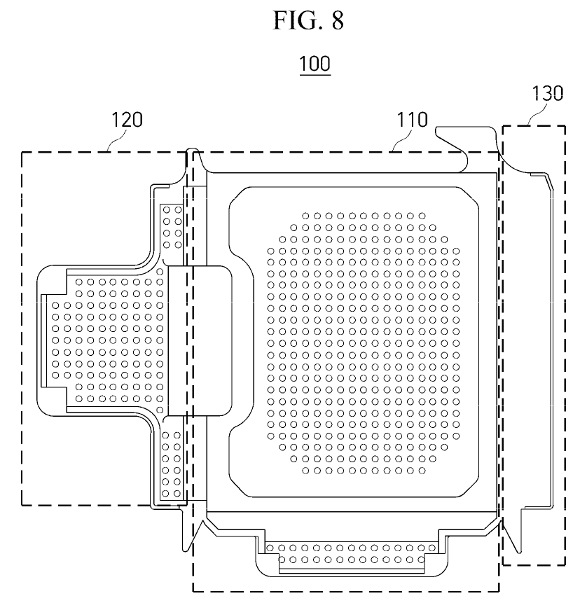

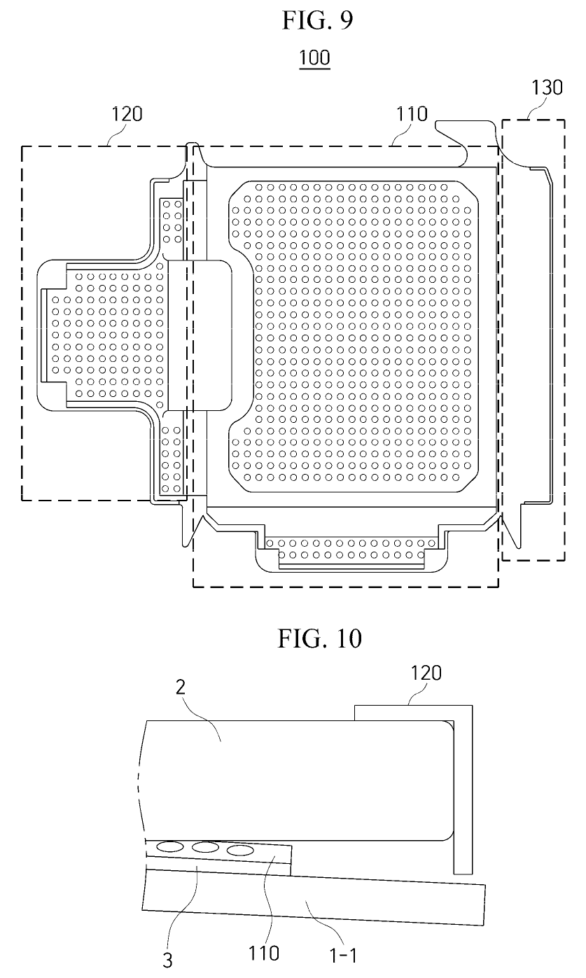

FIG. 8 is a diagram illustrating a pull tab tape according to an embodiment of the present disclosure. FIG. 9 is a diagram illustrating a pull tab tape according to another embodiment of the present disclosure.

Referring to FIGS. 8 and 9, the pull tab tape 100 according to embodiments of the present disclosure may have a seated part 110, a tab part 120, and a side cover part 130.

The seated part 110 may be at where the battery 2 seated thereon. An adhesive surface having a smaller area than the area of the battery 2 may be formed on a surface of the seated part 110 on which the battery 2 is seated. In some embodiments, as illustrated, for example, FIG. 8, the adhesive surface of the seated part 110 may be formed on the inside of (e.g., a central portion of) the surface on which the battery 2 is seated other than a plurality of corner parts of the surface on which the battery 2 is seated. FIG. 9 illustrates an embodiment having a larger adhesive surface toward the plurality of corner parts compared to the embodiment shown in FIG. 8.

In some embodiments, a plurality of adhesive dots may be formed on the adhesive surface of the seated part 110. The plurality of adhesive dots may be formed on the inside of (e.g., a central area of) the surface on which the battery is seated other than the plurality of corner parts of the surface on which the battery is seated. For example, the plurality of adhesive dots may be formed on the adhesive surface of the seated part 110.

When the battery 2 is seated, a surface of the tab part 120may be exposed to the outside (e.g., may extend beyond or outside a periphery of the battery 2). A user can easily dismantle (e.g., remove) the battery 2 because the tab part 120 is accompanied by (e.g., removed with) the battery 2 when the tab part 120 exposed to the outside is pulled.

The side cover part 130 may surround (or may extend around) the side of the battery 2. The side cover part 130 may hold the side of the battery 2 so that the pull tab tape 100 according to embodiments of the present disclosure is not pulled out.

FIG. 10 is a side cross-sectional view of a case in which the terminal device is twisted while the pull tab tape according to embodiments of the present disclosure is applied to the terminal device.

Referring to FIG. 10, a corner part of the surface of the seated part 110 on which the battery 2 is seated may be removed (or may not be adhesive) from the pull tab tape 100 according to embodiments of the present disclosure. Accordingly, a joint phenomenon or a phenomenon in which the adhesive surface is detached at the corner part of the surface on which the battery 2 is seated may not occur identically as the case shown in FIG. 6. In the embodiment shown in FIG. 10, the corner part of the surface on which the battery 2 is seated may be removed, that is, a cause in which the joint phenomenon or the phenomenon in which the adhesive surface is detached primarily occurs can be removed.

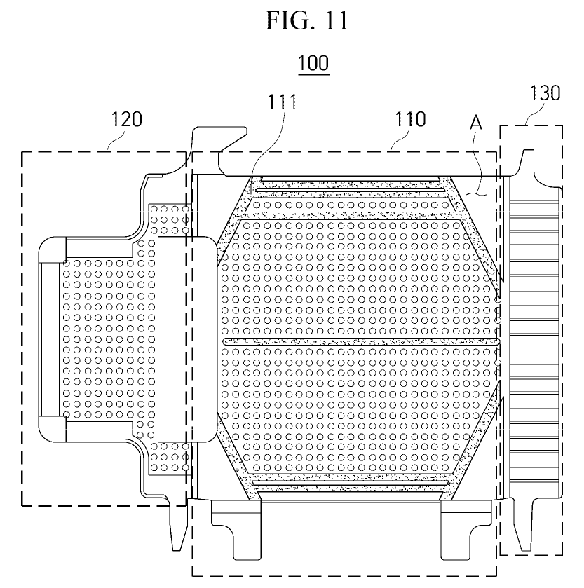

FIG. 11 is a diagram illustrating a pull tab tape according to another embodiment of the present disclosure.

Referring to FIG. 11, a plurality of corner parts of the surface on which the battery 2 is seated may be removed from the seated part 110 of the pull tab tape 100 according to embodiments of the present disclosure as indicated by A. In the illustrated embodiment, the corner parts at top left, top right, bottom left, and bottom right regions are removed, but the present disclosure is not limited thereto.

Furthermore, a strong adhesive line 111 having an adhesive that is stronger than another part of the adhesive surface may be formed at a part (or portion) of the adhesive surface of the seated part 110 of the pull tab tape 100 according to embodiments of the present disclosure. As illustrated in FIG. 11, the strong adhesive line 111 may be formed at an edge of the adhesive surface or at a part of the inside of the adhesive surface.

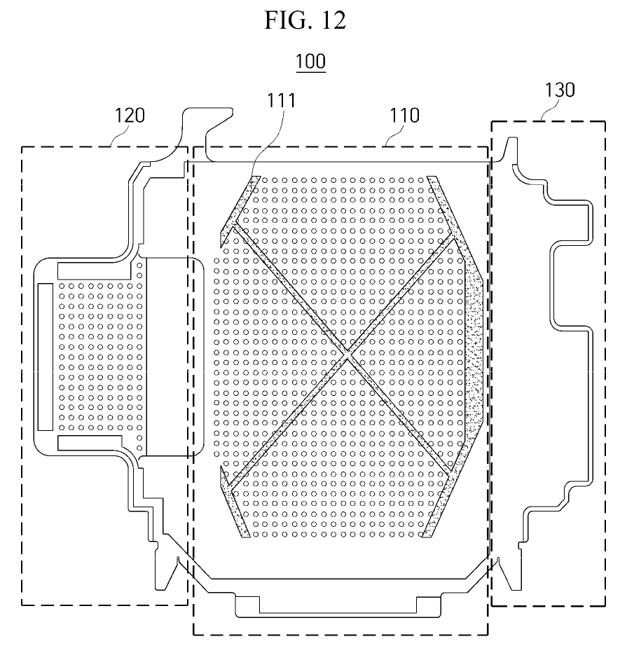

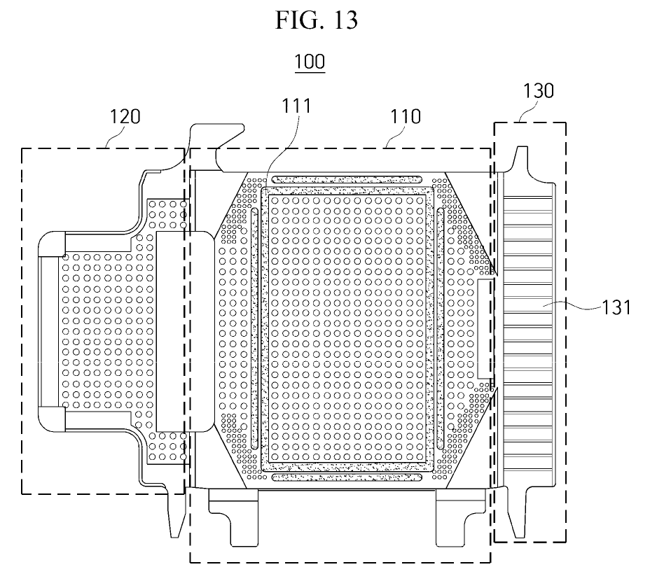

Hereinafter, embodiments of the pull tab tape 100 in which the strong adhesive line 111 is formed on the adhesive surface of the seated part 110 will be described with reference to FIGS. 12 and 13.

FIG. 12 is a diagram illustrating a pull tab tape according to another embodiment of the present disclosure.

Referring to FIG. 12, the strong adhesive line 111 may be formed at edges of the adhesive surface of the seated part 110 of the pull tab tape 100 according to embodiments of the present disclosure. Furthermore, the strong adhesive line 111 on the seated part 110 may be formed to cross (e.g., to extend across) the adhesive surface in an X shape. The strong adhesive line 111 having the X shape may reduce an area of the adhesive surface that is detached when the terminal device 1 is twisted or an impact is applied to the terminal device 1. The strong adhesive line 111 having the X shape can reduce the area in which the adhesive surface is detached up to a maximum of about 20%. In such an embodiment, the strong adhesive line 111 may have a width in a range of about 1.0 mm to about 2.0 mm.

FIG. 13 is a diagram illustrating a pull tab tape according to another embodiment of the present disclosure.

Referring to FIG. 13, the strong adhesive line 111 on the seated part 110 of the pull tab tape 100 according to embodiments of the present disclosure may be formed within the seated part 110 at a distance (e.g., at a predetermined distance) from an edge of the adhesive surface. When the strong adhesive line 111 is formed within the seated part 110 at a distance from the edge of the adhesive surface as described above, an adhesive force between the battery 2 and the adhesive surface is increased and a separation force is reduced because a strong adhesive force is formed toward the inside (or center) of the adhesive surface. As illustrated in FIG. 13, when the adhesive surface of the seated part 110 is formed of the plurality of adhesive dots and the strong adhesive line 111 is formed on the inside of (or inwardly of) three adhesive dots from the edge of the adhesive surface, a separation force may be reduced by a maximum of about 30% compared to the conventional pull tab tape. Furthermore, to increase or maximize the adhesive force reinforcement effect of the strong adhesive line 111, the strong adhesive line 111 may include two or more lines.

Furthermore, in some embodiments, air vents (e.g., openings) 131 through which air that is displaced when the battery 2 is seated in the seated part 110 can escape may be formed in the side cover part 130 of the pull tab tape 100 according to embodiments of the present disclosure. Conventionally, when the battery 2 is seated in the seated part 110, if the contact area of the battery 2 and the pull tab tape is widened, bubbles may be generated. Accordingly, poor dimensions or a poor appearance may occurs. Accordingly, the side cover part 130 of the pull tab tape 100 according to embodiments of the present disclosure can reduce or prevent the formation of bubbles because the air vents 131 are formed, allowing the air that is displaced when the battery 2 is seated in the seated part 110 escapes through the air vents. The air vents 131 may be formed in the side cover part 130 to form (or to provide) flow passages through which the air can move. In some embodiments, the air vents 131 may each have a width of about 1 mm and may be arranged at intervals of about 5 mm.

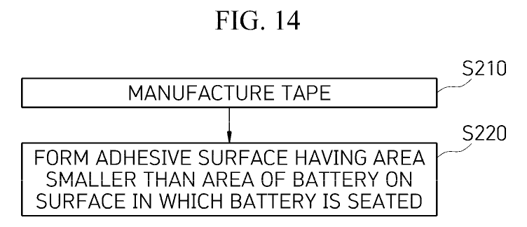

FIG. 14 is a flowchart describing a method of manufacturing a pull tab tape according to an embodiment of the present disclosure.

Referring to FIG. 14, a method of manufacturing a pull tab tape according to an embodiment of the present disclosure may include step S210 and step S220.

Step S210 may be a step of manufacturing a tape including the seated part on which the battery is to be seated, the tab part that is exposed to the outside on the surface that faces the surface on which the battery is seated when the battery is seated on the seated part, and the side cover part that extends around the side of the battery. In some embodiments, step S210 may include a step of forming the air vents through which the air that is displaced when the battery is seated in the seated part in the side cover part.

Step S220 may be a step of forming the adhesive surface having an area smaller than the area of the battery on the surface of the seated part on which the battery is seated. In some embodiments, step S220 may include a step of forming the adhesive surface on the inside of (or toward a center of) the surface on which the battery is seated other that at a plurality of corner parts of the surface on which the battery is seated. Furthermore, in some embodiments, step S220 may include a step of forming a strong adhesive line having an adhesive surface that is stronger than another part of the adhesive surface in a part of the adhesive surface.

The method of manufacturing a pull tab tape according to embodiments of the present disclosure has been described with reference to the flowcharts presented in the drawings. For a simple description, the method has been illustrated and described as a series of blocks, but the present disclosure is not limited to the sequence of the blocks, and some blocks may be performed in a sequence different from or simultaneously with that of other blocks, which has been illustrated and described in this specification. Various other branches, flow paths, and sequences of blocks which achieve the same or similar results may be implemented. Furthermore, all the blocks illustrated to implement the method described in this specification may not be required.

In the description given with reference to FIG. 14, each of the steps may be further divided into additional steps or the steps may be combined into smaller steps depending on an implementation example of the present disclosure. Furthermore, some of the steps may be omitted, if necessary, and the sequence of the steps may be changed. Furthermore, the contents of FIGS. 1A to 13, although some contents are omitted, may be applied to the contents of FIG. 14. Furthermore, the contents of FIG. 14 may be applied to the contents of FIGS. 1A to 13.

Hereinafter, materials which may be used in a secondary battery according to an embodiment of the present disclosure are described.

A compound (e.g., a lithiated intercalation compound) capable of reversible intercalation and deintercalation of lithium may be used as a positive electrode active material. For example, one type or more selected from among complex oxides of metal, selected from among cobalt, manganese, nickel, and a combination of them, and lithium may be used as the positive electrode active material.

The complex oxide may be lithium transition metal complex oxide. A detailed example of the complex oxide may include lithium nickel-based oxide, lithium cobalt-based oxide, lithium manganese-based oxide, a lithium ferrous phosphate-based compound, cobalt-free nickel-manganese-based oxide, or a combination of them.

For example, a compound that is represented as one of the following chemical formulas may be used. LiaA1-bXbO2-cDc (0.90≤a≤1.8, 0≤b≤0.5, 0≤c≤0.05); LiaMn2-bXbO4-cDc (0.90≤a≤1.8, 0≤b≤0.5, 0≤c≤0.05); LiaNi1-b-cCobXcO2-αDα (0.90≤a≤1.8, 0≤b≤0.5, 0≤c≤0.5, 0<α<2); LiaNi1-b-cMnbXcO2-αDα (0.90≤a≤1.8, 0≤b≤0.5, 0≤c≤0.5, 0<α<2); LiaNibCocL1dGeO2 (0.90≤a≤1.8, 0≤b≤0.9, 0≤c≤0.5, 0≤d≤0.5, 0≤e≤0.1); LiaNiGbO2 (0.90≤a≤1.8, 0.001≤b≤0.1); LiaCoGbO2 (0.90≤a≤1.8, 0.001≤b≤0.1); LiaMn1-bGbO2 (0.90≤a≤1.8, 0.001≤b≤0.1); LiaMn2GbO4 (0.90≤a≤1.8, 0.001≤b≤0.1); LiaMn1-gGgPO4 (0.90≤a≤1.8, 0≤g≤0.5); Li(3-f)Fe2(PO4)3 (0≤f≤2); and LiaFePO4 (0.90≤a≤1.8).

In the chemical formula, A may be Ni, Co, Mn, or a combination of them. X may be Al, Ni, Co, Mn, Cr, Fe, Mg, Sr, V, a rare earth element, or a combination of them; D may be O, F, S, P, or a combination of them. G may be Al, Cr, Mn, Fe, Mg, La, Ce, Sr, V, or a combination of them. L1 may be Mn, Al, or a combination of them.

A positive electrode for a lithium secondary battery may include a current collector and a positive electrode active material layer formed on the current collector. The positive electrode active material layer may include the positive electrode active material and may further include a binder and/or a conductive material.

Content of the positive electrode active material may be in a range of about 90 wt.% to about 99.5 wt.% with respect to the positive electrode active material layer 100 wt.%. Content of the binder and the conductive material may be in a range of about 0.5 wt.% to about 5 wt.% with respect to the positive electrode active material layer 100 wt.%.

Al may be used as the current collector, but the present disclosure is not limited thereto.

A negative electrode active material may include a material capable of reversibly Intercalation/de-intercalation with respect to lithium ions, lithium metal, an alloy of lithium metal, a material capable of doping and dedoping with respect to lithium, or transition metal oxide.

The material capable of reversibly Intercalation/de-intercalation with respect to lithium ions may include a carbon-based negative electrode active material, for example, crystalline carbon, amorphous carbon, or a combination of them. An example of the crystalline carbon may include graphite, such as natural graphite or synthetic graphite. Examples of the amorphous carbon may include soft or hard carbon, mesophase pitch carbide, and fired coke.

An Si-based negative electrode active material or an Sn-based negative electrode active material may be used as the material capable of doping and dedoping with respect to lithium. The Si-based negative electrode active material may be silicon, a silicon-carbon composite, SiOₓ (0<x<2), a Si-based alloy, or a combination of them.

The silicon-carbon composite may be a composite of silicon and amorphous carbon. According to an implementation example, the silicon-carbon composite may include silicon particles, and may have a form in which amorphous carbon has been coated on surfaces of silicon particles.

The silicon-carbon composite may further include crystalline carbon. For example, the silicon-carbon composite may include a core including crystalline carbon and silicon particles, and an amorphous carbon coating layer disposed on a surface of the core.

A negative electrode for a lithium secondary battery may include a current collector and a negative electrode active material layer disposed on the current collector. The negative electrode active material layer may include the negative electrode active material and may further include a binder and/or a conductive material.

For example, the negative electrode active material layer may include the negative electrode active material in a range of about 90 wt.% to about 99 wt.%, the binder in a range of about 0.5 wt.% to about 5 wt.%, and the conductive material in a range of 0 wt.% to about 5 wt.%.

A nonaqueous-based binder, an aqueous-based binder, a dry binder, or a combination of them may be used as the binder. If the aqueous-based binder is used as a binder for the negative electrode, the binder for the negative electrode may further include a cellulose-series compound capable of assigning viscosity.

One selected from among nickel foil, stainless steel foil, titanium foil, nickel foam, copper foam, a polymer base on which a conductive metal has been coated, and a combination of them may be used as a current collector for the negative electrode.

An electrolyte for a lithium secondary battery may include a nonaqueous organic solvent and lithium salts.

The nonaqueous organic solvent may act as a medium through which ions that are involved in an electrochemical reaction of a battery can move.

The nonaqueous organic solvent may be a carbonate-based, ester-based, ether-based, ketone-based, or alcohol-based solvent, an aprotic solvent, or a combination of them. The carbonate-based, ester-based, ether-based, ketone-based, or alcohol-based solvent, or the aprotic solvent may be used solely, or two types or more of them may be mixed and used as the nonaqueous organic solvent.

Furthermore, if the carbonate-based solvent is used, annular carbonate and chain carbonate may be mixed and used.

A separator may be present between the positive electrode and the negative electrode depending on the type of lithium secondary battery. Polyethylene, polypropylene, and polyvinylidene fluoride, or a multi-layer having two or more layers of them may be used as the separator.

The separator may include a porous base and a coating layer including an organic matter, an inorganic matter, or a combination of them that is disposed on one or both sides of the porous base.

The organic matter may include a polyvinylidene fluoride-based polymer or (meth)acrylic polymer.

The inorganic matter may include inorganic particles selected among Al2O3, SiO2, TiO2, SnO2, CeO2, MgO, NiO, CaO, GaO, ZnO, ZrO2, Y2O3, SrTiO3, BaTiO3, Mg(OH)2, boehmite, and a combination of them, but the present disclosure is not limited thereto.

The organic matter and the inorganic matter may have a form in which the organic matter and the inorganic matter have been mixed in one coating layer or a form in which a coating layer including the organic matter and a coating layer including the inorganic matter have been stacked.

Although the present disclosure has been described above in connection with embodiments as shown in the drawings, the present disclosure is not limited to the embodiments described herein. A person having ordinary knowledge in the art to which the present disclosure pertains may modify and change the present disclosure within the technical spirit of the present disclosure and the equivalent range of the following claims.

### Description of Some Reference symbols

100: pull tab tape 110: seated part

111: strong adhesive line 120: tab part

130: side cover part 131: air vent

What is claimed is:

1. A pull tab tape provided in a battery mounting part of a terminal device powered by a battery, the pull tab tape comprising:
a seated part on which the battery is seated, the seated part having an adhesive surface facing the battery and having an area smaller than an area of the battery on the seated part; and
a tab part exposed to an outside on a surface that faces the surface of the seated part on which the battery is seated when the battery is seated in the terminal device.

2. The pull tab tape as claimed in claim 1, wherein the adhesive surface of the seated part is at a central region thereof and not at a plurality of corner parts of the seated part on which the battery is seated.

3. The pull tab tape as claimed in claim 2, wherein:
the adhesive surface is formed by a plurality of adhesive dots on the seated part, and
the plurality of adhesive dots are on the central region of the seated part on which the battery is seated and are not at the plurality of corner parts of the seated part on which the battery is seated.

4. The pull tab tape as claimed in claim 2, wherein the plurality of corner parts of the seated part are removed from the seated part.

5. The pull tab tape as claimed in claim 2, wherein the seated part has a strong adhesive line having an adhesive stronger than another part of the adhesive surface.

6. The pull tab tape as claimed in claim 5, wherein the strong adhesive line of the seated part is at an edge of the adhesive surface.

7. The pull tab tape as claimed in claim 5, wherein the strong adhesive line of the seated part extends across the adhesive surface in an X shape.

8. The pull tab tape as claimed in claim 5, wherein the strong adhesive line of the seated part is within the seated part at a distance from an edge of the adhesive surface.

9. The pull tab tape as claimed in claim 1, further comprising a side cover part extending around a side of the battery.

10. The pull tab tape as claimed in claim 9, wherein the side cover part has air vents through which air displaced when the battery is seated on the seated part passes.

11. A method of manufacturing a pull tab tape to be provided in a battery mounting part of a terminal device that is powered by a battery, the method comprising:
manufacturing a tape comprising a seated part on which the battery is seated and a tab part exposed to an outside on a surface that faces a surface on which the battery is seated when the battery is seated; and
forming an adhesive surface on the seated part, the adhesive surface having an area smaller than an area of the battery on the surface of the seated part.

12. The method as claimed in claim 11, wherein the forming of the adhesive surface comprises forming the adhesive surface of the seated part on a central region of the surface on which the battery is seated and not at a plurality of corner parts of the surface on which the battery is seated.

13. The method as claimed in claim 12, wherein the forming of the adhesive surface comprises forming a plurality of adhesive dots to form the adhesive surface on an inside of the surface on which the battery is seated and not at a plurality of corner parts of the surface on which the battery is seated.

14. The method as claimed in claim 12, further comprising removing the plurality of corner parts from the seated part.

15. The method as claimed in claim 12, further comprising forming a strong adhesive line having an adhesive surface that is stronger than another part of the adhesive surface on a part of the adhesive surface of the seated part.

16. The method as claimed in claim 15, wherein the forming of the strong adhesive line comprises forming the strong adhesive line on the seated part at an edge of the adhesive surface.

17. The method as claimed in claim 15, wherein the forming of the strong adhesive line comprises forming the strong adhesive line on the seated part to extend across the adhesive surface in an X shape.

18. The method as claimed in claim 15, wherein the forming of the strong adhesive line comprises forming the strong adhesive line of the seated part at a distance from an edge of the adhesive surface.

19. The method as claimed in claim 11, wherein the manufacturing of the tape comprises forming a side cover part that extends around a side of the battery.

20. The method as claimed in claim 19, wherein the manufacturing of the tape comprising the side cover part comprises forming air vents through which air that is displaced when the battery is seated on the seated part passes through in the side cover part.
